(19) United States
(12) Patent Application Publication
(10) Pub. No.: US 2014/0025760 A1
(43) Pub. Date: Jan. 23, 2014

(54) AUTOMATICALLY GENERATED LINKS AND/OR SUGGESTED LINKS WITHIN A COMMUNITY OF INDIVIDUALS INTERFACED VIA A COMMUNICATION NETWORK

(71) Applicants: Matthew Shore, Belmont, CA (US); Huned M. Botee, San Francisco, CA (US)

(72) Inventors: Matthew Shore, Belmont, CA (US); Huned M. Botee, San Francisco, CA (US)

(21) Appl. No.: 13/945,604

(22) Filed: Jul. 18, 2013

Related U.S. Application Data
(60) Provisional application No. 61/673,088, filed on Jul. 18, 2012.

(51) Int. Cl. H04L 12/58

(52) U.S. Cl. CPC H04L 51/32
USPC 709/206

(57) ABSTRACT

Described herein are methods and systems for regulating the communication between a group of heterogeneous nodes. In one embodiment, the heterogeneous nodes include parents and their children. According to techniques of one embodiment of the present invention, children are permitted to communicate with one another via a social network if their respective parent(s) are acquaintances (e.g., dad of first child is a friend of dad of second child). Conversely, children are not permitted to communicate with one another via a social network if their respective parent(s) are not acquaintances. In one embodiment, one parent is an “acquaintance” of another parent, if the parents are connected via a social network.

### RELATED APPLICATIONS

This is a NONPROVISIONAL of, claims priority to and incorporates by reference U.S. Provisional Application No. 61/673,088 filed Jul. 18, 2012.

### FIELD OF THE INVENTION

The present invention relates, in general, to the facilitation of communication within a community of individuals interfaced via a communication network (e.g., social network), and more particularly to automatically generated links and/or suggested links within same.

### BACKGROUND

Social networking services (e.g., Facebook™ provided by Facebook Inc. of Menlo Park, Calif.; LinkedIn™ provided by LinkedIn Corp. of Mountain View, Calif.; and Google+™ provided by Google Inc. of Mountain View, Calif., etc.) are commonly used by individuals to communicate with one another (e.g., share pictures, send emails, send messages, etc.) and for individuals to form new connections with one another (e.g., send friend request, accept friend request, send invite, etc.) Until now, it appears social networks have focused on creating connections between only one kind of “node”, i.e., homogeneous nodes. On LinkedIn, for instance, one node (i.e., user) may be no different than any other node (i.e., user) in terms of the actions that a node can perform. A user can request to connect to anyone, etc.

### SUMMARY OF THE INVENTION

While homogeneous nodes may function well in a community of peers (e.g., individuals with peer-to-peer relationships), a heterogeneous collection of nodes may be more suited in other settings. In various embodiments of the present invention, techniques are provided to facilitate the communication between a heterogeneous collection of nodes, which may be present due to hierarchical relationships between the nodes. Parents-children, managers-employees, teachers-students are but a few examples of such relationships. In a community with a heterogeneous collection of nodes, it may be appropriate to assign different capabilities to different nodes. In terms of communication for individuals with parent-children relationships, children should not be able to “friend” anyone they like. Instead, it would be more desirable if children are required to seek their respective parents' approval before a “friend request” is granted. As further described below, it is possible to infer certain links between individuals based on such hierarchical relationships and use those links to create networks that enable communication protocols for digital media, such networks replicating communication channels that exist in an offline setting.

The present application introduces the notion of a network based on one or more hierarchies of nodes. In one embodiment, there are primary and secondary nodes (e.g., parents are primary nodes and their children are secondary nodes). Primary nodes and their respective secondary nodes form “clusters.” Clusters can be linked only when a primary from one cluster is linked to a primary from another cluster—secondary nodes can never produce or accept an invitation. In this way, primary nodes control communication to and among secondary nodes.

A few points are noted (and further described below) regarding this formulation: One, more than one primary node is possible in a cluster (e.g., mom and dad are both primary nodes). Two, at an appropriate time, a secondary node can be “promoted” to become a primary node. Three, it is possible for a node to simultaneously be a secondary and primary node. For instance, a manager may oversee certain employees (i.e., have responsibilities of a primary node), but that manager may also report to higher-up management (i.e., also have responsibilities of a secondary node).

Returning to an embodiment concerning individuals characterized by parent-children relationships, certain content and connections with certain individuals may not be appropriate for children under a certain age or maturity level. Feeling defenseless or anxious, many parents simply prohibit their children from joining a social network until a certain age. However, such a decision may simply be a “knee-jerk” reaction and overly restrict a child's social development in an on-line setting. Many parents feel comfortable with their children talking with their classmates, siblings, cousins, in an off-line setting, and would likely feel comfortable if their children were to communicate with at least some of their peers (or other individuals) in an on-line setting. Of course, a parent could set a whitelist and blacklist of individuals with whom their children could communicate with over a social network. While such scheme may work and indeed may be part of one embodiment of the present invention, the inventors have developed a more convenient and automated way for a parent to set up a restricted social network for his/her child. It is noted that while much of the description will center around parents and their children, as should be apparent, the present concepts/algorithms may be extended to other communities of individuals in which other types of relationships are present, such as an academic community with teacher-student relationships, a workplace community with manager-employee relationships, etc.

Further, it is noted that parent-child relationships are commonly used to describe hierarchical relationships between nodes in computer science graph theory. While such graph theory concepts may apply to some embodiments of the present invention, a parent-child relationship may, in many instances, specifically refer to a familial relationship, rather than purely a graph theoretic hierarchical relationship.

In one embodiment of the present invention, if one parent is connected with another parent (e.g., another parent such as a neighbor, co-worker, brother, brother-in-law, college friend, dentist, piano teacher, etc.) in a social network, these parents will allow their respective children to be connected with one another over a social network. The thought is that if two parents are connected with one another, these parents have established a certain degree of trust between themselves. Perhaps, these parents have known each other for many years, meet once in a while for coffee, are colleagues at work, are relatives, etc. If this is so, these parents are likely comfortable with their respective children communicating with one another in an online setting. If any inappropriate communication (e.g., use of swear words, bullying, etc.) does occur between two children, their respective parents know one another, and thus are able to monitor, police and/or terminate the inappropriate communication. Therefore, in a system according to one embodiment of the present invention, if two parents are connected with one another, links (e.g., communication channels and the like, which are further described below) may be implicitly/automatically created between their respective children. Conversely, if two parents are not connected with one another, their children are not allowed to communicate with one another over a social network, and no link is created between their respective children.

In some sense, children “inherit” the connections of their respective parents. The concept of inherited connections, in which certain connections can be inferred, is a convenient aspect of one embodiment of the present invention. Due to inferred connections, a restricted network with pre-established connections (i.e., automatically generated links) may be formed and/or suggested links may be provided to a user, without an administrator (e.g., parent) explicitly specifying connections or specifying whitelisted and/or blacklisted contacts. Such concepts, as will be more fully explained below, extend readily to other contexts outside parent-child relationships.

For example, when a cluster is formed (e.g., a teacher signs up herself and all of her students), everyone within that cluster (e.g., second grade class) may be implicitly linked (e.g., students may be linked with one another and the teacher may be linked with each student). When two primaries connect (e.g., second grade teacher and third grade teacher connect with one another), an explicit link may be created between the two primaries (e.g., between second grade teacher and third grade teacher) and implicit links may be created between all of the secondaries of a primary and the other primary (e.g., between second grade students and third grade teacher) as well as all the secondaries of a primary and all the secondaries of the other primary (e.g., between second grade students and third grade students).

These and other embodiments of the invention are more fully described in association with the drawings below.

### BRIEF DESCRIPTION OF THE DRAWINGS

The present invention is illustrated by way of example, and not limitation, in the figures of the accompanying drawings in which:

FIG. 1 depicts an interconnection of nodes, in accordance with one embodiment of the invention;

FIG. 2 depicts an interconnection of nodes, in accordance with one embodiment of the invention;

FIG. 3 depicts an interconnection of nodes, in accordance with one embodiment of the invention;

FIG. 4 depicts an interconnection of nodes, in accordance with one embodiment of the invention;

FIG. 5 depicts an interconnection of nodes, in accordance with one embodiment of the invention;

FIG. 6 depicts an interconnection of clusters, each cluster having one or more nodes, in accordance with one embodiment of the invention;

FIG. 7 depicts an interconnection of clusters, each cluster having one or more nodes, in accordance with one embodiment of the invention;

FIG. 8 depicts an interconnection of clusters, each cluster having one or more nodes, in accordance with one embodiment of the invention;

FIG. 9 depicts an interconnection of groups, each group including one or more individuals, in accordance with one embodiment of the invention;

FIG. 10 depicts an exemplary user interface for a user to enter his/her personal information, contact information, configuration information, and/or other information, in accordance with one embodiment of the invention;

FIG. 11 depicts an exemplary table of information regarding members of a family, in accordance with one embodiment of the invention;

FIG. 12 depicts an exemplary user interface for a user to form his/her connections to other users, in accordance with one embodiment of the invention;

FIG. 13 depicts an exemplary user interface for a user to configure his/her connections with other users, in accordance with one embodiment of the invention;

FIG. 14 depicts an exemplary user interface for a user to configure his/her children's connections with other users, in accordance with one embodiment of the invention;

FIG. 15 depicts an exemplary user interface that facilitates communication between individuals of a child-secure social network, in accordance with one embodiment of the invention;

FIG. 16 depicts an exemplary user interface associated with an internal messaging tool, in accordance with one embodiment of the invention;

FIG. 17 depicts an exemplary user interface for a user to communicate with other users via various channels of communication, in accordance with one embodiment of the invention;

FIG. 18 depicts a system diagram detailing the flow of information between individuals and various modules/databases, in accordance with one embodiment of the invention;

FIG. 19 depicts a system diagram detailing the flow of information between individuals and various modules/databases, in accordance with another embodiment of the invention;

FIG. 20 depicts a network diagram including client devices and a server; and

FIG. 21 depicts components of a computer system in which computer readable instructions instantiating the methods of the present invention may be stored and executed.

### DETAILED DESCRIPTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

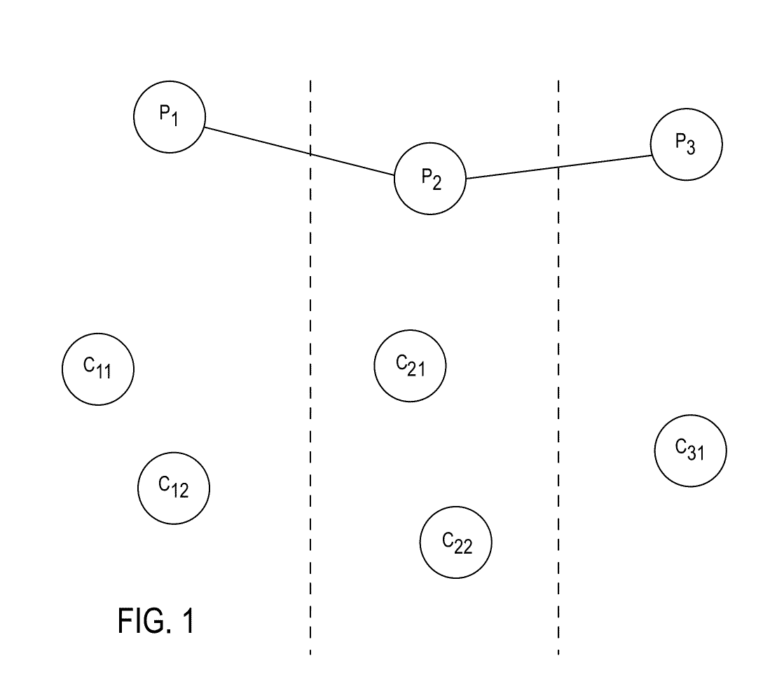

FIGS. 1-5 illustrate the concept of inherited connections, according to one embodiment of the present invention, in more detail. FIG. 1 depicts a collection of 3 primary nodes and 5 secondary nodes. Primary node 1 is represented as node “p₁”; primary node 2 is represented as node “p₂”; and primary node 3 is represented as node “p₃”. Primary node 1 has two secondary nodes (i.e., nodes c₁₁ and c₁₂); primary node 2 also has two secondary nodes (i.e., nodes c₂₁ and c₂₂); and primary node 3 has one secondary node (i.e., node c₃₁). Vertical dashed lines are depicted to visually segregate nodes belonging to each cluster of nodes.

Further, a line between p₁ and p₂ indicates that communication is authorized between primary nodes 1 and 2; and a line between p₂ and p₃ indicates that communication is authorized between primary nodes 2 and 3. No line is present between primary nodes 1 and 3, indicating that primary nodes 1 and 3 are not authorized to communicate with one another. Of course, primary nodes 1 and 3 are indirectly connected with one another through primary node 2, and such indirect connection may or may not be taken into account in an embodiment of the present invention. Typically, unless noted otherwise, indirectly connected nodes, such as p₁ and p₃ will be regarded as not being connected.

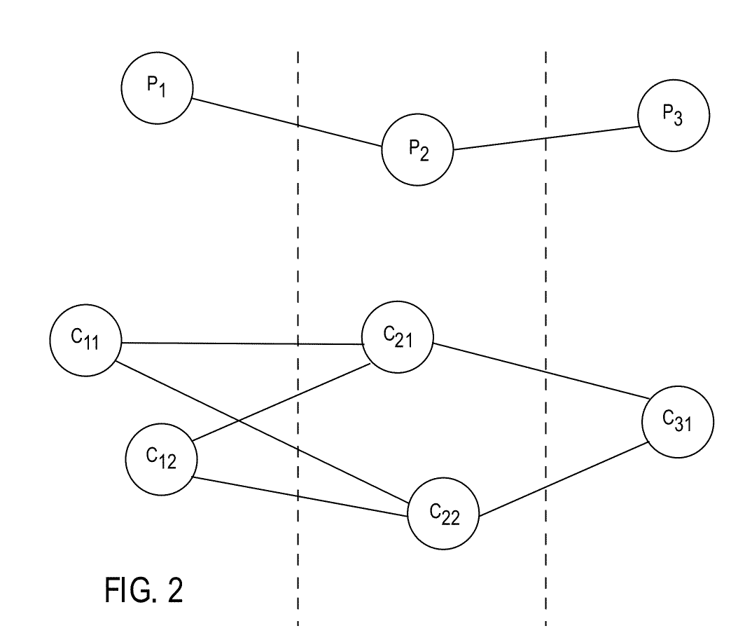

A system, in accordance with one embodiment of the present invention, takes such connections as inputs, and generates one or more of the implicit and/or inferred connections further depicted in FIGS. 2-5. In much of the description, such implicit and/or inferred connections may result in automatically generated links, although it is understood that suggested links might be provided instead, in which a user may have the opportunity to accept or decline a suggested link. For example, a third grade student may be invited to connect with a second grade student, in response to his/her third grade teacher being connected with a second grade teacher. The third grade student may either accept or decline that invitation (i.e., opportunity to be linked with the second grade student).

As depicted in FIG. 2, one or more secondary-secondary (i.e., secondary node to secondary node) links may be automatically generated in response to a corresponding primary-primary (i.e., primary node to primary node) link. Specifically, connections may be automatically generated between the two secondary nodes of primary node 1 and the two secondary nodes of primary node 2, in response to a connection between primary nodes 1 and 2 (i.e., c₁₁ and c₁₂ may be each connected to c₂₁ and c₂₂). Likewise, connections may be automatically generated between the two secondary nodes of primary node 2 and the secondary node of primary node 3 (i.e., c₂₁ and c₂₂ may be each connected to c₃₁). It is noted that the secondary nodes of primary node 1 and the secondary node of primary node 3 may not be (directly) linked and/or may in fact be prohibited from being linked with one another, in response to no (direct) link being present between primary nodes 1 and 3.

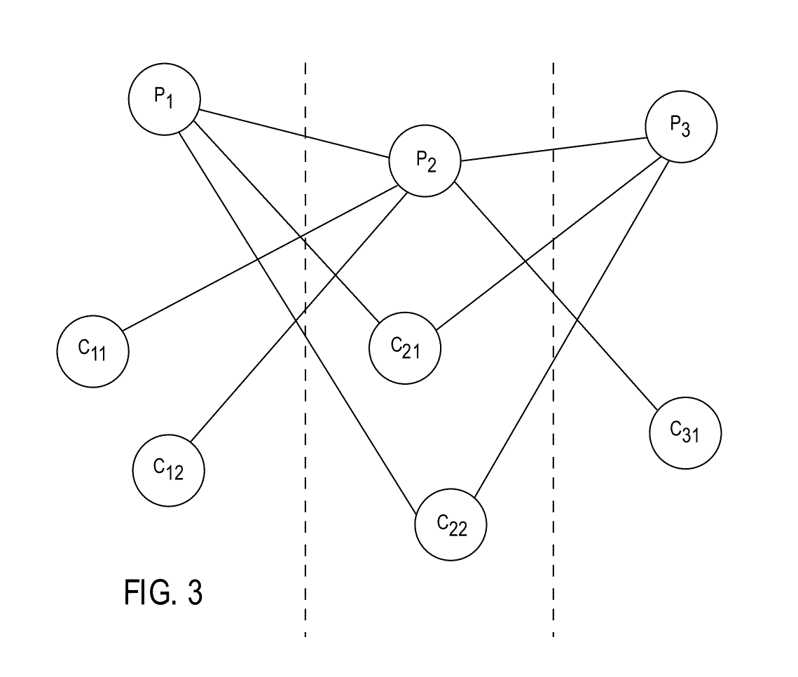

As depicted in FIG. 3, one or more secondary-primary (i.e., secondary node to primary node) links may also be automatically generated in response to a corresponding primary-primary link. The secondary nodes of primary node 1 may be connected with primary node 2 (i.e., c₁₁ and c₁₂ may be automatically linked to p₂) and the secondary nodes of primary node 2 may be connected with primary node 1 (i.e., c₂₁ and c₂₂ may be automatically linked to p₁). Likewise, the secondary nodes of primary node 2 may be connected with primary node 3 (i.e., c₂₁ and c₂₂ may be automatically linked to p₃) and the secondary node of primary node 3 may be connected with primary node 2 (i.e., c₃₁ may be automatically linked to p₂). It is noted that primary node 3 and the secondary nodes of primary node 1 may not be (directly) linked and/or may be prohibited from being linked with one another, in response to no (direct) link being present between primary nodes 1 and 3.

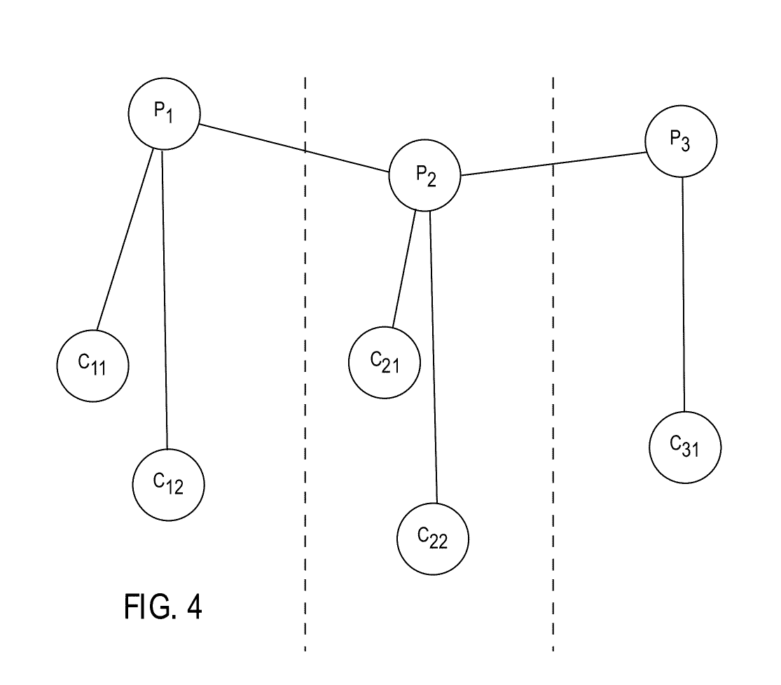

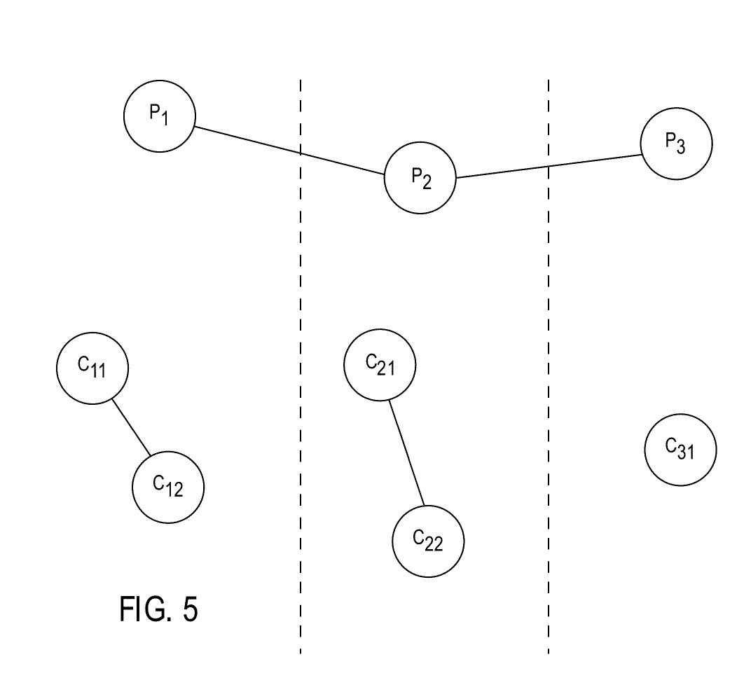

While FIGS. 2 and 3 depict links that may be automatically formed in response to primary-primary links, FIGS. 4 and 5 depict links that may be automatically formed in response to relationships within a cluster. FIG. 4 depicts links that may be automatically formed between a primary node and its respective secondary nodes. FIG. 5 depicts links that may be automatically formed between two secondary nodes, as a result of two secondary nodes sharing a common primary node.

In a familial context, FIG. 1 may more specifically depict a collection of 3 parents and their children (i.e., 5 children total across the 3 families). Parent 1 is represented as node “p₁”; parent 2 is represented as node “p₂”; and parent 3 is represented as node “p₃”. Parent 1 has two children (i.e., nodes c₁₁ and c₁₂); parent 2 also has two children (i.e., nodes c₂₁ and c₂₂); and parent 3 has one child (i.e., node c₃₁). Vertical dashed lines are depicted to visually segregate nodes belonging to each family.

Further, a line between p₁ and p₂ indicates that communication is authorized between parents 1 and 2; and a line between p₂ and p₃ indicates that communication is authorized between parents 2 and 3. No line is present between parents 1 and 3, indicating that parents 1 and 3 are not authorized to communicate with one another. Of course, parents 1 and 3 are indirectly connected with one another through parent 2, and such indirect connection may or may not be taken into account in an embodiment of the present invention. Typically, unless noted otherwise, indirectly connected individuals, such as p₁ and p₃ will be regarded as not being connected.

The two aforementioned connections may be established in a conventional manner. For example, parent 1 may send a “friend request” to parent 2 and parent 2 may accept same. In another scenario, parent 1 lists parent 2 as a contact, and parent 2 also lists parent 1 as a contact, and such settings may be sufficient to establish a connection between parent 1 and parent 2. Regardless of the particular manner in which the aforementioned connections are established, a system in accordance with one embodiment of the present invention, takes such connections as inputs, and generates one or more of the implicit connections further depicted in FIGS. 2-5.

As depicted in FIG. 2, one or more child-child (i.e., child to child) links may be automatically generated in response to a corresponding parent-parent (i.e., parent to parent) link. Specifically, connections may be automatically generated between the two children of parent 1 and the two children of parent 2, in response to a connection between parents 1 and 2 (i.e., c₁₁ and c₁₂ may be each connected to c₂₁ and c₂₂). Likewise, connections may be automatically generated between the two children of parent 2 and the child of parent 3 (i.e., c₂₁ and c₂₂ may be each connected to c₃₁). It is noted that the children of parent 1 and the child of parent 3 may not be (directly) linked and/or may in fact be prohibited from being linked with one another, in response to no (direct) link being present between parents 1 and 3.

As depicted in FIG. 3, child-parent (i.e., child to parent) links may also be automatically generated in response to a corresponding parent-parent link. The children of parent 1 may be connected with parent 2 (i.e., c₁₁ and c₁₂ may be automatically linked to p₂) and the children of parent 2 may be connected with parent 1 (i.e., c₂₁ and c₂₂ may be automatically linked to p₁). Likewise, the children of parent 2 may be connected with parent 3 (i.e., c₂₁ and c₂₂ may be automatically linked to p₃) and the child of parent 3 may be connected with parent 2 (i.e., c₃₁ may be automatically linked to p₂). It is noted that parent 3 and the children of parent 1 may not be (directly) linked and/or may be prohibited from being linked with one another, in response to no (direct) link being present between parents 1 and 3.

While FIGS. 2 and 3 depict links that may be automatically formed in response to parent-parent links, FIGS. 4 and 5 depict links that may be automatically formed in response to family relationships. FIG. 4 depicts links that may be automatically formed between a parent and his/her child, as result of a parent designating an individual as his/her child. FIG. 5 depicts links that may be automatically formed between siblings, as a result of a parent designating two or more individuals as his/her children.

So far, the discussion has mentioned that child-child and/or child-parent links may be automatically formed in response to an associated parent-parent link. In other embodiments of the invention, such feature may be modified. Instead of child-child and/or child-parent links being automatically formed in response to an associated parent-parent link, a parent-parent link may simply enable a child-child and/or child-parent linked to be formed. Stated differently, a parent-parent link may be a pre-condition required for the creation of an associated child-child and/or child-parent link. Whether the associated child-child and/or child-parent link is actually created may depend on other factors, such as whether two children actually know one another, whether a child knows a friend of his/her parent, etc. In yet another embodiment, a parent-parent link may result in a suggested child-child and/or suggested child-parent link. Upon being presented with such a suggested link, a user may have the option to accept or decline such link.

It is noted that a parent-child relationship may be generalized. A parent, more generally can be substituted with an individual's guardian, caretaker, nanny, baby-sister, grandparent, foster-parent, teacher, manager, etc., including anyone who exercises a certain degree of control over an individual. A child, more generally can be substituted with an individual's grandchild, foster-child, student, subordinate, etc., including anyone who relies upon, depends on, and/or listens to the instructions of the individual.

One can imagine the scenario where two adults are connected via a social network, but it may not be appropriate for their children to be connected with one another. Perhaps, the first adult's children are teenagers, whereas the second adult's children are already in college. Therefore, not all children in the broadest sense should be considered as “children” in the language of the present application. “Children” in the present application refers to, for example, juveniles, dependents, individuals below a certain age, for example 11, 12, 13, 14, 15, 16 or 17, middle school students, high school students, etc. When a child crosses a certain threshold, in terms of age, maturity, responsibility, etc., he/she may receive greater control over his/her social network. Such increase in freedom/autonomy may occur over multiple stages, rather than at a particular threshold. For example, a child's privileges may be increased upon elementary school graduation, middle school graduation and/or high school graduation. Eventually, a child is expected to be able to freely form his/her own connections over a social network, with privileges identical to that of his/her parent(s). Procedures concerning such graduation or promotion of a child and/or secondary node will be further discussed below.

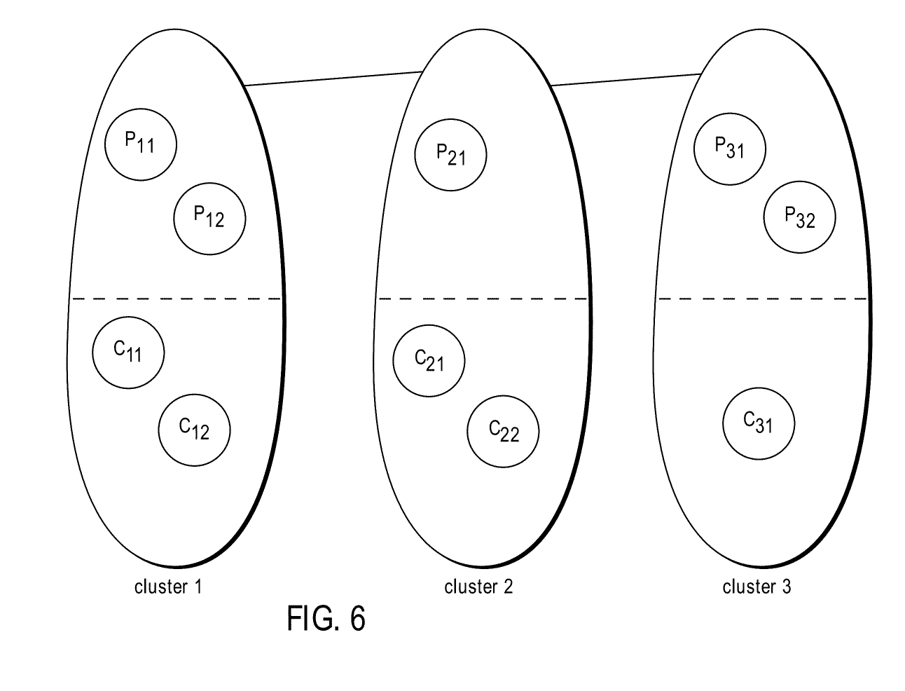

In another embodiment of the invention, primary nodes and secondary nodes are grouped into clusters. In contrast to the embodiments depicted in FIGS. 1-5, in the instant embodiment, the system stores connections between clusters, instead of and/or in addition to connections between individual nodes. Using clusters, it may be simpler to manage the respective connections of clusters with two or more primary nodes, in contrast to the embodiments depicted in FIGS. 1-5, which may be more suited for embodiments where each secondary node has a unique primary node. As depicted in FIG. 6, cluster 1 includes the two primary nodes p₁₁ and p₁₂, and their associated secondary nodes c₁₁ and c₁₂; family 2 includes the primary node p₂₁ and its associated secondary nodes c₂₁ and c₂₂; and family 3 includes the two primary nodes p₃₁ and p₃₂, and its associated secondary node c₃₁. A dashed horizontal line within each cluster separates the primary nodes from the secondary nodes. More generally, such dashed horizontal line may separate nodes (i.e., individuals) that have the authority to form connections between clusters, from those that do not have such authority.

As depicted in FIG. 6, a line connects cluster 1 with cluster 2, indicating that communication is authorized between at least one individual from cluster 1 and at least one individual from cluster 2. Likewise, a line connects cluster 2 with cluster 3, indicating that communication is authorized between at least one individual from cluster 2 and at least one individual from cluster 3. The inherited links and/or automatically generated links, as described with respect to FIGS. 1-5, may be extended to the configuration depicted in FIG. 6.

Similar to the above-described secondary-secondary links formed in response to a primary-primary link, in FIG. 6, a secondary-secondary link may be formed in response to a cluster-cluster link. Specifically, in response to cluster 1 being connected with cluster 2, links may be automatically generated between the secondary nodes of cluster 1 and the secondary nodes of cluster 2 (i.e., c₁₁ connected to c₂₁ and c₂₂, and c₁₂ connected to c₂₁ and c₂₂). For conciseness of explanation, such interconnection may be referred to as a mesh network between (c₁₁, c₁₂) and (c₂₁, c₂₂), in which all individuals of the former cluster are connected with all individuals of the latter cluster, and vice versa. Likewise, in response to cluster 2 being connected with cluster 3, a mesh network may be automatically generated between (c₂₁, c₂₂) and (c₃₁). Such secondary-secondary connections have not been depicted in FIG. 6 so as to not clutter the presentation of FIG. 6. However, it should be clear to one of ordinary skill in the art, in view of FIG. 2, how these connections may be depicted.

Similar to the above-described secondary-primary links formed in response to a primary-primary link, in FIG. 6, a secondary-primary link may be formed in response to a cluster-cluster link. Specifically, in response to cluster 1 being connected with cluster 2, a mesh network may be automatically generated between (c₁₁, c₁₂) and (p₂₁) and a mesh network may be automatically generated between (p₁₁, p₁₂) and (c₂₁, c₂₂). Likewise, in response to cluster 2 being connected with cluster 3, a mesh network may be automatically generated between (p₂₁) and (c₃₁) and a mesh network may be automatically generated between (c₂₁, c₂₂) and (p₃₁, p₃₂). Such secondary-primary connections have also not been depicted in FIG. 6 so as to not clutter the presentation of FIG. 6. However, it should be clear to one of ordinary skill in the art, in view of FIG. 3, how these connections may be depicted.

Similar to the discussion above, links may be automatically formed within each cluster. Primary nodes may be automatically linked, e.g., p₁₁ linked to p₁₂. Secondary nodes may be automatically linked, e.g., c₁₁ linked to c₁₂. Likewise, primary nodes may be automatically linked with their associated secondary nodes, e.g., a mesh network between (p₁₁, p₁₂) and (c₁₁, c₁₂). Such secondary-primary, secondary-secondary connections have also not been depicted in FIG. 6 so as to not clutter the presentation of FIG. 6. However, it should be clear to one of ordinary skill in the art, in view of FIGS. 4-5, how these connections may be depicted.

Further, in response to cluster 1 being connected with cluster 2, a mesh network may be formed between (p₁₁, p₁₂) and (p₂₁); however, this is not always so. In another embodiment, only a subset of these connections may be established, such as only a connection between p₁₁ and p₂₁ or only a connection between p₁₂ and p₂₁. Similar comments apply to the interconnections between p₂₁, p₃₁ and p₃₂, in response to cluster 2 being connected with cluster 3. Such primary-primary connections have also not been depicted in FIG. 6 so as to not clutter the presentation of FIG. 6.

In yet another embodiment, a link between primary nodes belonging to different clusters triggers the respective clusters to be linked to one another.

In a familial context, the clusters, primary nodes, and secondary nodes of FIG. 6 may more specifically correspond to families, parents, and children, respectively. In contrast to the embodiments depicted in FIGS. 1-5, in the instant embodiment, the system stores connections between families, instead of and/or in addition to connections between parents. Using family groups, it may be simpler to manage the respective connections of families with two parents, in contrast to the embodiments depicted in FIGS. 1-5, which may be more suited for families with a single parent. As depicted in FIG. 6, family 1 includes the two parents p₁₁ and p₁₂, and their children c₁₁ and c₁₂; family 2 includes the parent p₂₁ and his/her children c₂₁ and c₂₂; and family 3 includes the two parents p₃₁ and p₃₂, and their child c₃₁. A dashed horizontal line within each family group separates individuals who are parents from those who are children. More generally, such dashed horizontal line may separate individuals who have the authority to form connections between family groups, from those who do not have such authority.

As depicted in FIG. 6, a line connects family 1 with family 2, indicating that communication is authorized between at least one individual from family 1 and at least one individual from family 2. Likewise, a line connects family 2 with family 3, indicating that communication is authorized between at least one individual from family 2 and at least one individual from family 3. The inherited links and/or automatically generated links, as described with respect to FIGS. 1-5, may be extended to the configuration depicted in FIG. 6.

Similar to the above-described child-child links formed in response to a parent-parent link, in FIG. 6, a child-child link may be formed in response to a family-family link. Specifically, in response to family 1 being connected with family 2, a mesh network may be automatically generated between (c₁₁, c₁₂) and (c₂₁, c₂₂). Likewise, in response to family 2 being connected with family 3, a mesh network may be automatically generated between (c₂₁, c₂₂) and (c₃₁). Such child-child connections have not been depicted in FIG. 6 so as to not clutter the presentation of FIG. 6. However, it should be clear to one of ordinary skill in the art, in view of FIG. 2, how these connections may be depicted.

Similar to the above-described child-parent links formed in response to a parent-parent link, in FIG. 6, a child-parent link may be formed in response to a family-family link. Specifically, in response to family 1 being connected with family 2, a mesh network may be automatically generated between (c₁₁, c₁₂) and (p₂₁) and a mesh network may be automatically generated between (p₁₁, p₁₂) and (c₂₁, c₂₂). Likewise, in response to family 2 being connected with family 3, a mesh network may be automatically generated between (p₂₁) and (c₃₁) and a mesh network may be automatically generated between (c₂₁, c₂₂) and (p₃₁, p₃₂). Such child-parent connections have also not been depicted in FIG. 6 so as to not clutter the presentation of FIG. 6. However, it should be clear to one of ordinary skill in the art, in view of FIG. 3, how these connections may be depicted.

Similar to the discussion above, links may be automatically formed within each family group. Spouses may be automatically linked, e.g., p₁₁ linked to p₁₂. Siblings may be automatically linked, e.g., c₁₁ linked to c₁₂. Likewise, parents may be automatically linked with their children, e.g., a mesh network between (p₁₁, p₁₂) and (c₁₁, c₁₂). Such child-parent, child-child connections have also not been depicted in FIG. 6 so as to not clutter the presentation of FIG. 6. However, it should be clear to one of ordinary skill in the art, in view of FIGS. 4-5, how these connections may be depicted.

Further, in response to family 1 being connected with family 2, a mesh network may be formed between (p₁₁, p₁₂) and p₂₁; however, this is not always so. In another embodiment, only a subset of these connections may be established, such as only a connection between p₁₁ and p₂₁ or only a connection between p₁₂ and p₂₁. Similar comments apply to the interconnections between p₂₁, p₃₁ and p₃₂, in response to family 2 being connected with family 3. Such parent-parent connections have also not been depicted in FIG. 6 so as to not clutter the presentation of FIG. 6.

In yet another embodiment, a link between parents belonging to different families triggers the respective families to be linked to one another.

In addition to family, a cluster may more generally refer to other groupings of individuals, such as a group of individuals within a class, club, organization, company, sports team, volunteer group, etc. Further, the “dashed horizontal line” is merely a visual tool which helps illustrate the concept of segregation within a cluster, and it is understood that such segregation may, in practice, be implemented in various ways, such as tags/variables/flags associated with an identifier of each individual. Further, while FIG. 6 depicts only 2 sub-groups within each cluster, more sub-groups are possible. For example, children may be further segregated by gender, and accordingly, it is possible to automatically create links between children of the same gender. For instance, Ann may not feel comfortable with her teenage daughter communicating with Bob's teenage son over a social network, and thus automatically prohibiting all boy-girl communication over a social network may be a convenient feature, but may feel comfortable with her teenage daughter communicating with Bob's teenage daughter over a social network, and thus automatically allowing all boy-boy, girl-girl communication over a social network may be a convenient feature.

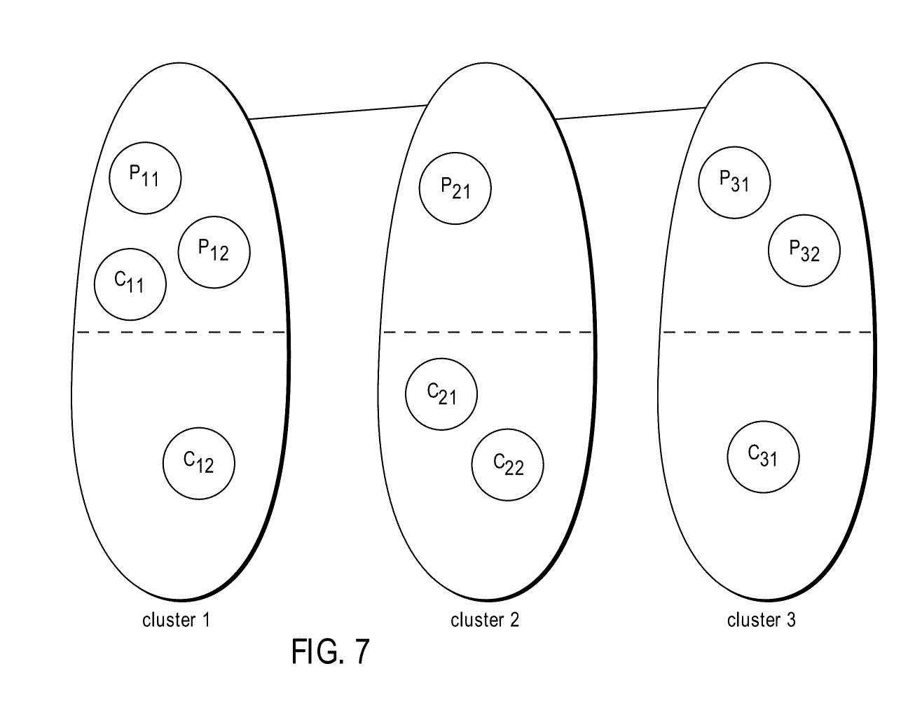

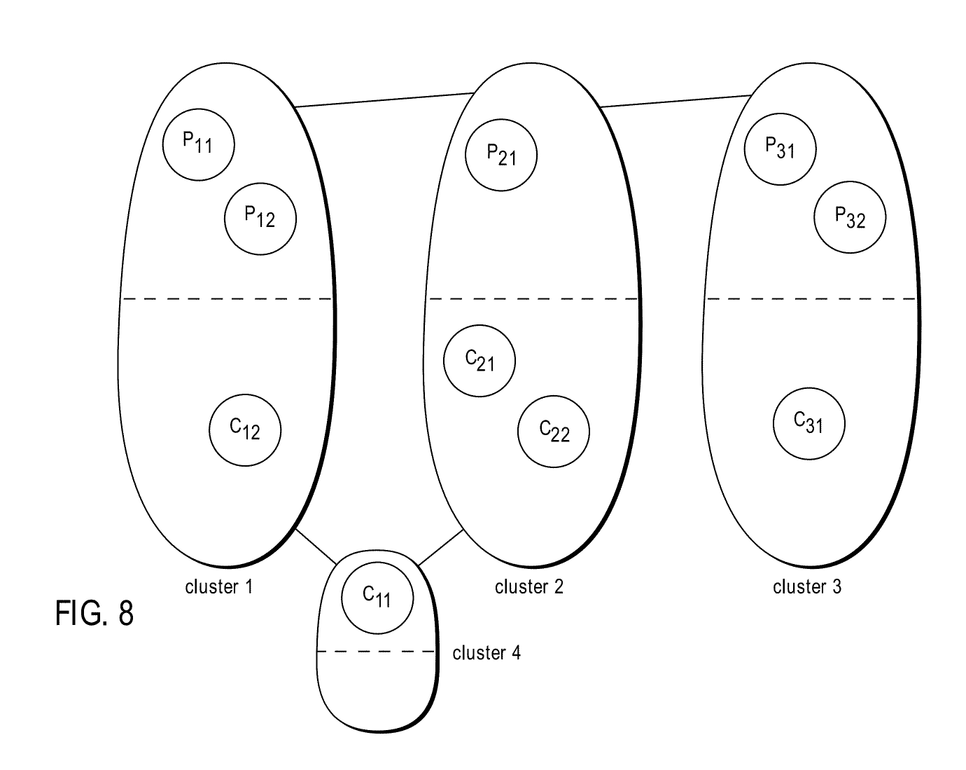

FIGS. 7 and 8 illustrate possible modifications to FIG. 6, upon a secondary node being “promoted” into a primary node, in accordance with some embodiments of the invention. In the example of FIG. 6, assume that secondary node c₁₁ is being promoted. Such promotion may result in c₁₁ joining the sub-group containing primary nodes p₁₁ and p₁₂, as depicted in FIG. 7. In this scenario, c₁₁ would then receive the same privileges as the primary nodes, and would, for example, be allowed to create new connections for cluster 1.

In accordance with another embodiment of the invention, c₁₁ could be assigned to a new cluster, as depicted in FIG. 8. More precisely, upon c₁₁'s promotion, c₁₁ could be removed from cluster 1 and be assigned to a new cluster (i.e., cluster 4). Upon the creation of a new cluster, certain inter-cluster connections may be automatically created. Since c₁₁ was formerly part of cluster 1 and may have been formerly connected with individuals from cluster 1, it may be convenient to automatically create a link between cluster 1 and cluster 4. Likewise, since c₁₁ may have been formerly connected with certain individuals of cluster 2 (due to the cluster 1-cluster 2 link), it may be convenient to automatically link cluster 4 and cluster 2 with one another. Such new cluster-cluster connections are depicted in FIG. 8. As a result of being promoted, c₁₁ may establish a connection with individuals from cluster 3, if he/she so desires.

In a familial context, FIGS. 7 and 8 illustrate possible modifications to FIG. 6, upon a child being “promoted”, in accordance with some embodiments of the invention. For example, upon a child's graduation from high school, his/her parents may feel it is appropriate for him/her to start establishing connections with anyone, any family, etc., of his/her choice. In the example of FIG. 6, assume that child c₁₁ is being promoted. Such promotion may result in c₁₁ joining his/her parent's sub-group, as depicted in FIG. 7. In this scenario, c₁₁ would then receive the same privileges as his/her parents, and would be allowed to create new connections for family 1.

In accordance with another embodiment of the invention, c₁₁ could establish his/her own family, as depicted in FIG. 8. More precisely, upon c₁₁'s promotion, c₁₁ could leave family 1 and create his/her own family (i.e., family 4). Upon the creation of a new family, certain family connections may be automatically created. Since c₁₁ was formerly part of family 1 and may have been formerly connected with individuals from family 1, it may be convenient to automatically create a link between family 1 and family 4. Likewise, since c₁₁ may have been formerly connected with certain individuals of family 2 (due to the family 1-family 2 link), it may be convenient to automatically link family 4 and family 2 with one another. Such new family-family connections are depicted in FIG. 8. As a result of being promoted, c₁₁ may establish a connection with individuals from family 3, if he/she so desires.

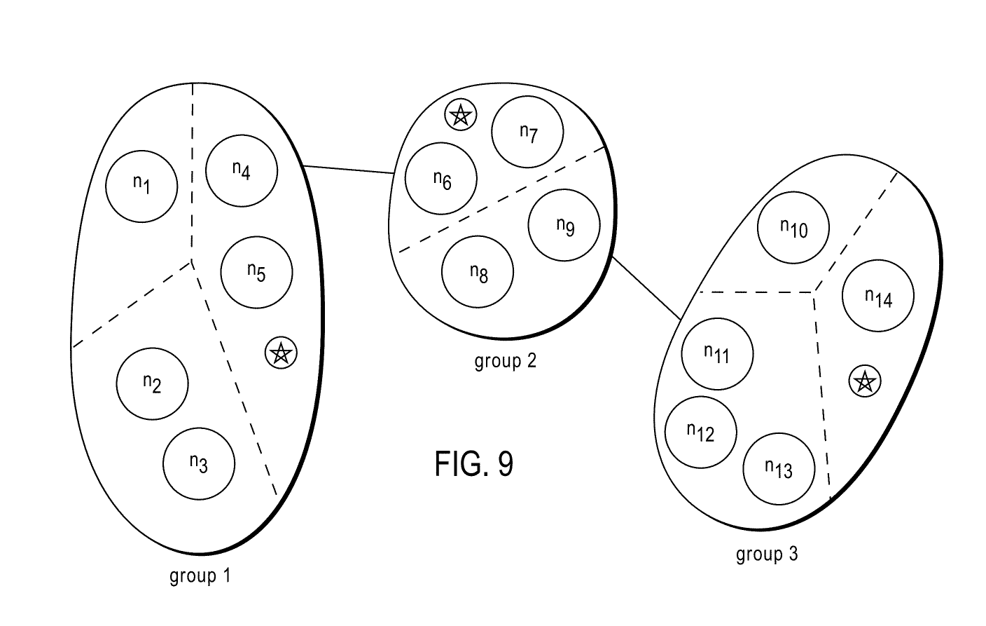

In a more general setting, outside a primary-secondary node paradigm and parent-child paradigm, it may not be apparent from the context which sub-group has the authority to form inter-group connections. Consider, for example, the arrangement of 13 individuals into 3 groups depicted in FIG. 9, in which the individuals are simply designated as n₁ through n₁₃. In such community of individuals, it may be necessary to designate one of the sub-groups within a group as that which has authority to form connections with other groups. For ease of discussion, we will refer to such sub-group as a “super-sub-group”, and in FIG. 9, such “super-sub-groups” have been indicated with a star. In FIG. 9, the two individuals n₄ and n₅ have the authority to form, for group 1, connections to other groups. The two individuals n₄ and n₅ may correspond to parents from the earlier discussion. In contrast, the three individuals n₁, n₂ and n₃ may not have the authority to form, for group 1, connections to other groups. The three individuals n₁, n₂ and n₃ may correspond to children from the earlier discussion. The segregation between n₁ and (n₂, n₃) may indicate that n₁ is in high school, while (n₂, n₃) are in middle school. Such discussion, however, is only exemplary and is not intended to be limiting. Similar description applies to groups 2 and 3. In other contexts, it may make sense to have more than one “super-sub-group”. Perhaps, one “super-sub-group” has the authority to create and remove connections, while another “super-sub-group” has the authority to only remove, but not create connections.

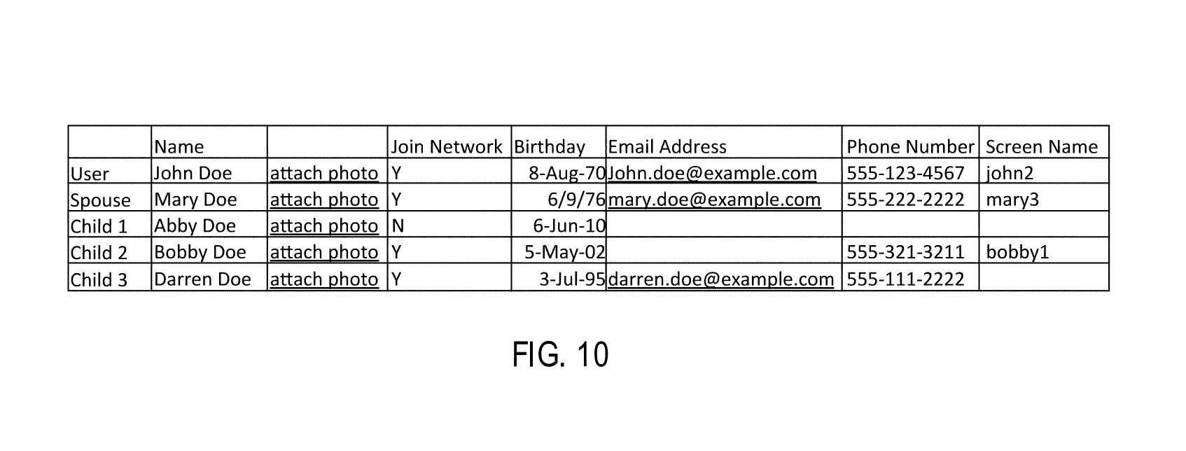

FIGS. 10-16 depict various exemplary user interfaces associated with a system facilitating the child-secure social network described herein. FIG. 10 depicts a user-interface which allows a user (i.e., typically a parent) to enter his/her personal information, contact information, configuration information, and/or other information. In the example depicted in FIG. 10, the user is named John Doe. The columns titled Birthday, Email Address and Phone Number are self-explanatory. The column titled Screen Name may be a FaceTime, Skype, AIM, Lync, or other screen name. The user is allowed to enter corresponding information for his/her spouse, and any number of his/her children. In the present example, John Doe's spouse is Mary Doe, and John Doe has three children named Abby Doe, Bobby Doe and Darren Doe. The personal information of birthday may be useful for several purposes. By way of a user's birthday, the system may determine a user's age. If a user is too young (e.g., age below a certain threshold), the system may automatically prohibit the user from joining the child-secure social network. If a user becomes old enough (e.g., age exceeds a certain threshold), the system may automatically promote a user, in accordance with the techniques described above. The user is allowed to attach photographs (or more generally any image) for himself/herself and each member of his/her family. Such images may be used to facilitate the communication between users, as further described below. The user is also allowed to designate whether certain members of his/her family may join the child-secure social network via the column titled “Join Network”.

Note that all fields may be optional. An individual need not have an email address, phone number, and/or screen name, yet communication with other individuals is still possible, since a user may, in practice, be identified by any one of the fields (Name, photograph, birthday, etc.)

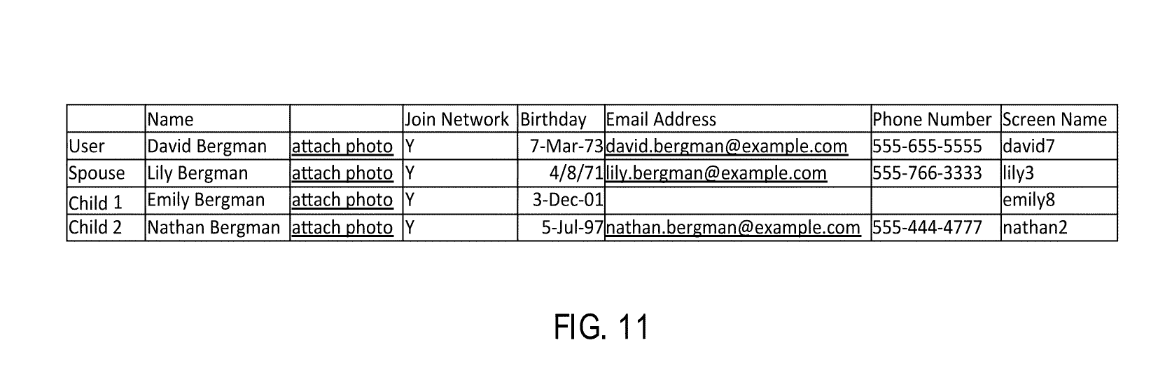

FIG. 11 depicts an exemplary table of information provided by another user, David Bergman. All completed fields of FIG. 11 should be self-explanatory, and need not require any further explanation.

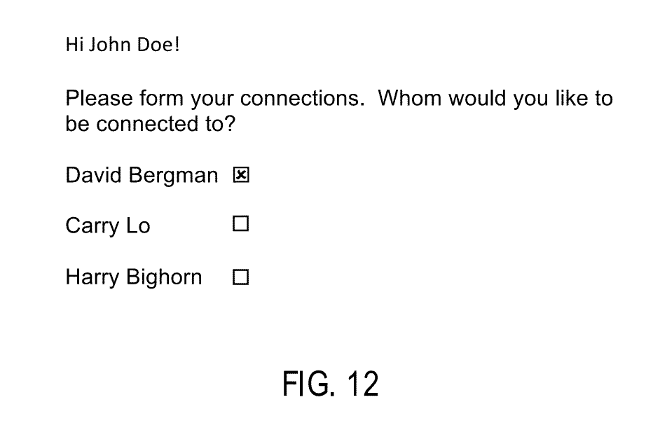

After providing the above-described personal information, contact information, configuration information, and/or other information, a user may be provided the opportunity to connect with other users of the child-secure social network. In the example depicted in FIG. 12, John Doe is provided the opportunity to connect with David Bergman, Carry Lo and Harry Bighorn. John Doe chooses to connect with David Bergman, as indicated by the X′ed box. In reference to the connection diagrams depicted in FIGS. 2-5, such selection may form a parent-parent connection between John Doe and David Bergman. Alternatively, or in addition, such selection may form a family-family connection between the Doe and Bergman families, in reference to the connection diagram depicted in FIG. 6.

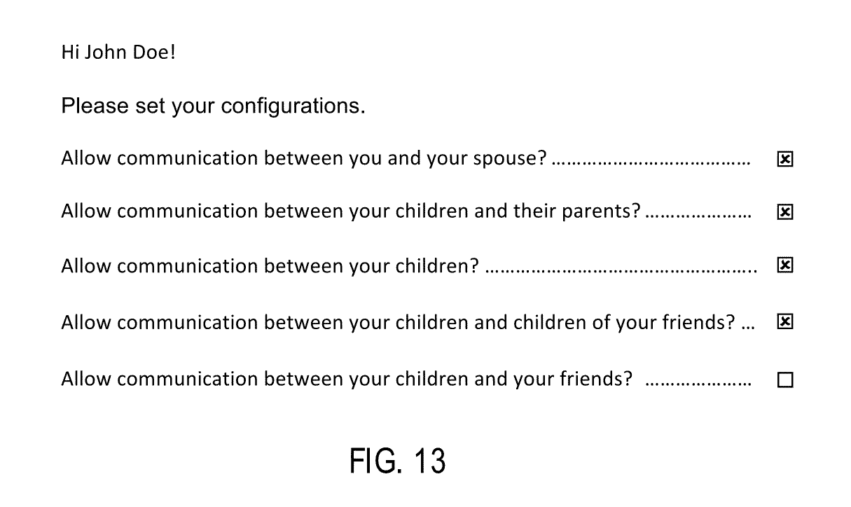

In one embodiment of the invention, a user (e.g., parent) is also provided the opportunity to set certain configurations that regulate the automatic generation of links, as depicted in FIG. 13. For instance, a user may allow or not allow communication between himself/herself and his/her spouse; a user may allow or may not allow communication between himself/herself and his/her children; a user may allow or may not allow communication between his/her children, in the event that he/she has more than one child; a user may allow or may not allow communication between his/her children and the children of his/her friends; and a user may allow or may not allow communication between his/her children and his/her friends. In the present example, John Doe has elected to allow the first 4 modes of communication, but not the last mode. In another embodiment of the invention, certain modes of communication may be selected by default, while other modes of communication may be prohibited by default. Of course, the opportunity to set such configurations are not similarly provided to children, and therefore, such configurations are neither opt-in nor opt-out options from the point of view of children.

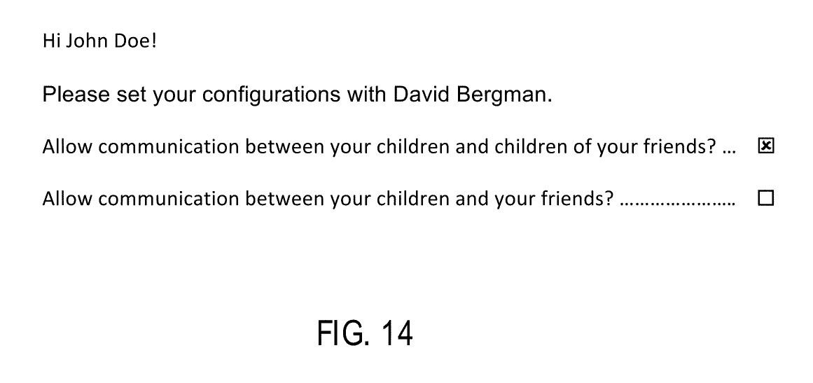

The configurations presented in FIG. 13 are “global” configurations that are not specific to any child, friend, etc. Alternatively or in addition to the configurations presented in FIG. 13, the user may be offered the opportunity to select “local” configurations, e.g., configurations that apply to specific children, friends, etc., such as those depicted in FIG. 14. In FIG. 14, a user (e.g., John Doe) is provided with an opportunity to select configurations specific to a certain friend (e.g., David Bergman). The user may allow or may not allow communication between his/her children and the children of that friend; and the user may allow or may not allow communication between his/her children and that friend. If there are inconsistencies between the local and global configurations, the local configurations may override the global configurations.

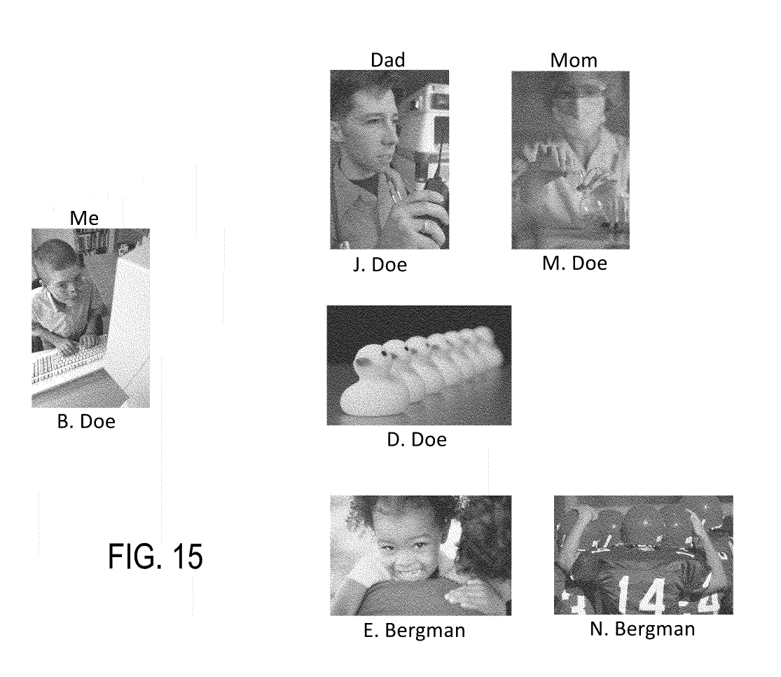

FIG. 15 depicts an example user interface that facilitates communication between individuals of the child-secure social network. In the present example, Bobby Doe is signed into the social network (details of a sign-in process are well-known and have been omitted for conciseness). On the left side of the user interface, Bobby's picture is displayed (although such placement is exemplary, and other placement is of course possible). On the right side of the user interface, pictures of individuals with whom Bobby may communicate with are depicted. In the present example, Bobby may communicate with his dad (John Doe), his mom (Mary Doe), his brother (Darren Doe), his dad's friend's daughter (Emily Bergman) and his dad's friend's son (Nathan Bergman).

John Doe and Mary Doe have been selected as people that Bobby may communicate with, because John Doe designated that communication between his children and their parents is to be allowed. Darren Doe has been selected, because John Doe designated that communication between his children is to be allowed. Emily Bergman and Nathan Bergman have been selected, because John Doe designated that communication between his children and the children of his friends is to be allowed. David Bergman and Lily Bergman are absent, because John Doe did not designate that communication between his children and his friends is to be allowed.

It is noted that all 5 communication links between (Bobby Doe and John Doe), (Bobby Doe and Mary Doe), (Bobby Doe and Darren Doe), (Bobby Doe and Emily Bergman) and (Bobby Doe and Nathan Bergman) have been automatically generated, in accordance with the principles described above. The links between (Bobby Doe and John Doe), (Bobby Doe and Mary Doe) are examples of the links previously described in FIG. 4. The links between (Bobby Doe and Darren Doe) are examples of the links previously described in FIG. 5. The links between (Bobby Doe and Emily Bergman) and (Bobby Doe and Nathan Bergman) are examples of the links previously described in FIG. 2. It is also noted that since Bobby Doe was designated as a child (i.e., was entered in the field “Child 2” in FIG. 10), Bobby is not offered the opportunity to input any additional individuals to his social network. Stated differently, Bobby is confined to communication with the 5 individuals depicted on the right-hand side of FIG. 15, the system, in accordance with one embodiment, providing a restricted network for Bobby Doe. Such configuration, while limiting, is designed to prevent Bobby from communicating with other individuals that his parents may not feel comfortable with him communicating with over a social network. In contrast to groups that a user may choose to join (i.e., opt-in) or choose to leave (i.e., opt-out), Bobby may not have any ability to alter the automatically generated group of individuals specifically generated for and/or assigned to him.

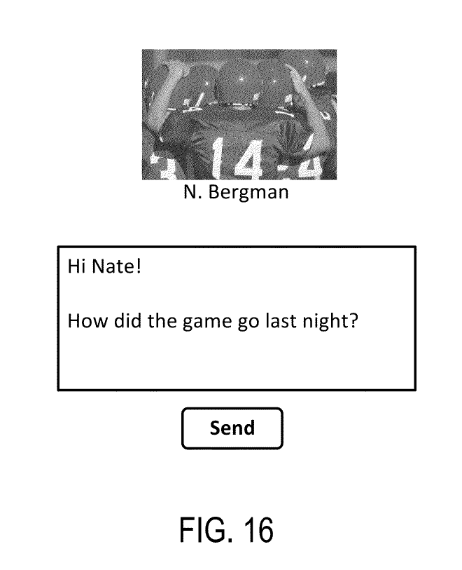

To communicate with any of the 5 individuals, Bobby, in one embodiment of the invention, need only select the picture associated with the desired individual to activate an internal messaging tool. Selection on a personal computer may be performed using a cursor-controlled device (e.g., mouse, trackball, joystick, etc.). Selection on a mobile device with a touch screen interface may be performed by touching a picture (or image) associated with the desired individual. FIG. 16 depicts a further user interface that may appear, upon Bobby selecting the picture of Nathan Bergman, for Bobby to utilize the internal messaging tool. A text box may be present, in which Bobby may input a message to communicate to Nathan. Selection of a “Send” icon then triggers the message to be sent. Bobby may then receive a reply from Nathan on the same user-interface screen, similar to a conventional chat/messaging interface. It is noted that such communication between Bobby and Nathan may not require or involve either user's e-mail address or screen name, as such communication may utilize an internally assigned identifier associated with each individual.

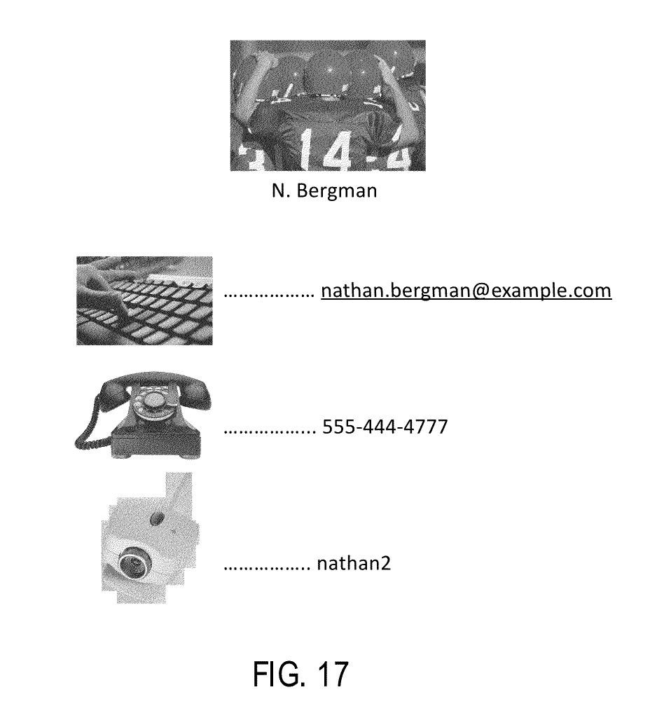

In another embodiment of the invention, selection of an individual's picture triggers the display of another user interface, such as that depicted in FIG. 17, which allows the user to further specify whether he/she desires to send an e-mail to another individual, call another individual, or video conference with another individual. Channels of communication, other than those depicted, are possible. These channels of communication may occur within an entirely closed and secure system, or may take place between an internal contact point (i.e., a contact point within the closed and secure system) and an external contact point (i.e., a Gmail e-mail account, a Facebook account, a cell phone number, etc.). An internal and/or external contact point may be implicitly whitelisted, if it is associated with an individual included within a user's restricted network. In other words, if user A and user B are linked, user A may communicate directly with user B's Gmail e-mail account, user B's Facebook account, user B's cell phone number, etc.

Regarding e-mail communication, the sender of an e-mail, in one embodiment of the present invention, may or may not have an e-mail address on record. If the sender of an e-mail has an e-mail address on record, the sender may simply send an e-mail from such e-mail address. If, however, the sender of an e-mail does not have an e-mail address on record (such as, Bobby Doe, who has no e-mail address on record), the system, according to one embodiment, may create a default e-mail address for the sender. For instance, Bobby Doe may be automatically assigned the e-mail address [user name] at childsecurenetwork dot com. Further, for a user (such as Nathan Bergmann) who has an external e-mail address on record ([user name] at example dot com), a message sent to a user's internal e-mail address (e.g., [user name] at childsecurenetwork dot com) may be automatically copied to the user's external e-mail address.

As generally described above, there are, in accordance with one embodiment, two primary modes for communicating on the child-secure social network: using native in-app tools, such as the internal messaging tool described above, and using external messaging tools, such as gmail and yahoo mail. In response to an email message being sent from an external messaging tool to a user within the child-secure social network, the system, in one embodiment, may route the email message to a message thread associated with the intended recipient user and also ensure that the sender is a registered primary node in the child-secure social network who is linked to the recipient user.

In order to support communication via external tools while preserving security (as described previously), the system, in one embodiment, may also dynamically generate an email address that uniquely identifies a user of the child-secure social network and a corresponding message thread. The system may also ensure that the sender is a primary node that is connected to the receiving user, who can be a primary or secondary node. In order for the latter to work, a primary node that wishes to use external email tools to communicate with a secondary node must register his/her email address as part of his/her profile.

In one embodiment, primary nodes can find the system generated email addresses of other users they are linked to within the child-secure social network by examining respective profiles of the other users and also by receiving messages originating within the child-secure social network in their external email inboxes, in addition to managing messages in an internal messaging tool.

It is noted that the above-mentioned channels of communication (e.g., messaging, sharing photos, sending e-mail) may not be all available to a child, depending on further configuration settings. For example, the parent may selectively control whether his/her child may send/receive a message, an image, an e-mail, and/or a video to/from a specific recipient/sender.

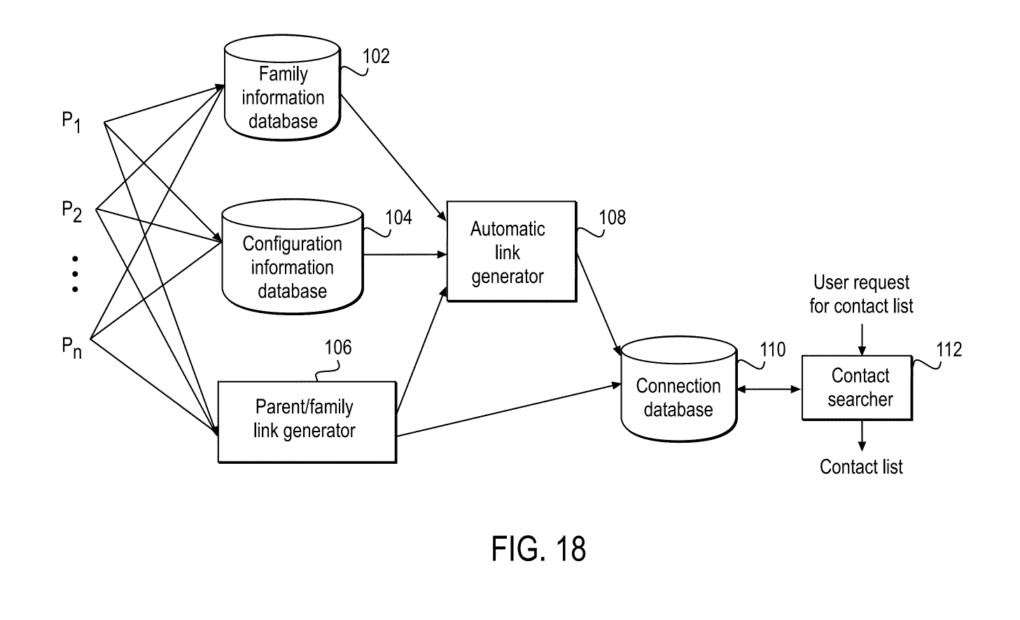

FIG. 18 depicts a system diagram detailing the flow of information between individuals (e.g., parents, children, teachers, students, etc.) and various modules/databases, in accordance with one embodiment of the present invention. While the present invention may be applied to more general contexts, the description below is targeted at contexts having parent-child relationships, for conciseness and ease of explanation.

As depicted in FIG. 18, at least two parents (e.g., p₁, p₂, . . . pₙ) may provide information concerning themselves and their respective families to family information database 102. Such information, as explained above, may include a parent's name, their children's name(s), birthdays, contact information (e.g., including e-mail addresses, phone numbers, screen names, etc.), photographs of family members, etc. With respect to the example discussed above, such information may correspond to that provided in FIGS. 10 and 11.

Parents may also provide configuration information to configuration information database 104. Such information, as explained above, may indicate whether a parent allows his/her child to be a member of a social network. Such information, as explained above, may also indicate whether a parent permits communication, over the social network, between himself/herself and his/her child, between siblings, between his/her child and a child of his/her acquaintance, and/or between his/her child and his/her acquaintance. Such information, as explained above, may also selectively control whether a child may send/receive emails, messages, images, video, etc. In the example discussed above, such information may correspond to that provided in FIGS. 10-11 and 13.

The parents may also communicate with parent/family link generator 106, which establishes whether communication is to be allowed, over a social network, between two parents and/or two families. In the example discussed above, such information may be that provided in FIG. 12 (e.g., link generated between John Doe and David Bergman, or Doe and Bergman families, in response to John Doe's selection to connect with David Bergman). Additionally, the parent/family link generator may receive as inputs a friend request (e.g., user A wants to be friends with user B) and an acceptance of a friend request (e.g., user B accepts user A as a friend), and in response, generates a link between user A and user B.

In response to data received from family information database 102, configuration information database 104 and parent/family link generator 106, automatic link generator 108 automatically generates one or more links between two or more individuals. Such automatically generated links may include, as explained above, a link between a first and second individual, in response to information specifying that the first and second individuals belong to the same family (e.g., the first individual is a parent of the second individual, the first and second individuals are siblings), in response to information specifying that communication is authorized between a parent of the first individual and a parent of the second individual, in response to information specifying that communication is authorized between a parent of the first individual and the second individual, and/or in response to information specifying that communication is authorized between a first family including the first individual and a second family including the second individual. Such automatically generated links have been previously described in FIGS. 2-9.

Links generated by automatic link generator 108 and links generated by parent/family link generator 106 may be collectively stored in connection database 110.

In response to a user's request for a contact list (e.g., a collect of individuals with whom the user may contact), contact searcher 112 queries connection database 110 to determine individuals appropriate for the user to contact over a social network (or more generally, a communication network). In the example discussed above, the user may be Bobby Doe, and contact searcher 112 would inform Bobby Doe that he may contact John Doe, Mary Doe, Darren Doe, Emily Bergman and Nathan Bergman.

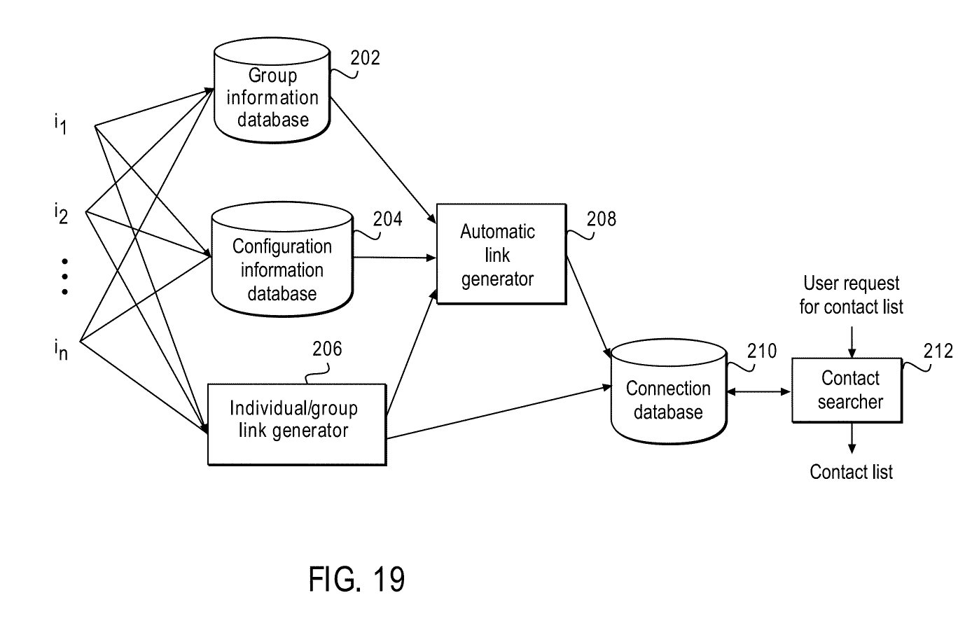

FIG. 19 depicts a system diagram similar to that depicted in FIG. 18, except FIG. 19 is applicable to a more general setting, and is not specific to the parent-child setting described in FIG. 18. In FIG. 19, n individuals (i₁, i₂, . . . iₙ) may store their respective personal information as well as information concerning their respective groups to group information database 202. For example, individual i₁ may be a teacher, and the teacher may store his/her name as well as the names of his/her students in group information database 202. The individuals may also store certain configuration information to configuration information database 204. In an example involving teachers and students, a teacher may put forth the requirement that only students of the same grade level be allowed to communicate with one another over a social network, only students, not previously suspended or otherwise disciplined, be allowed to communicate with one another over a social network, etc. The individuals may also form connections with one another and/or form connections between groups via individual/group link generator 206. In an example involving teachers and students, Prof. Williams may notify individual/group link generator 206 that Prof Davidson is a colleague, and Prof. Davidson may notify individual/group link generator 206 that Prof. Williams is a colleague, and in response, individual/group link generator 206 may form a connection between Prof. Williams and Prof. Davidson. As another example, Prof. Williams may notify individual/group link generator 206 that the Organic Chemistry 101A and Biology 1B classes should be linked with one another, and in response, individual/group link generator 206 may form a connection between the Organic Chemistry 101A and Biology 1B classes.

Automatic link generator 108, in response to information from group information database 202, configuration information database 204, and individual/group link generator 206, may automatically generate links. In the example involving teachers and students, automatic link generator 208 may automatically generate a link (e.g., allow communication over a communication network) between a student in Organic Chemistry 101A and Biology 1B.

Links generated by automatic link generator 208 as well as links generated by individual/group link generator 206 may be stored in connection database 210.

In response to a user request for a contact list, contact searcher 212 may query connection database 210 to determine individuals appropriate for the user to contact over the social network. Such a contact list may resemble a list of friends in Facebook, or a list of contacts in LinkedIn. Therefore, in some embodiments, contact searcher 212 may automatically generate a social network for the user. In other embodiments, contact searcher 212 may return a list of suggested contacts/connections for a user.

In another embodiment of the invention, contact searcher 212 may be replaced or may be supplemented with a contact filter (not depicted). In response to a first individual's request to contact a second individual (e.g., send email via Gmail, send friend request via Facebook, etc.), the contact filter queries the connections database to determine whether the connection between the first individual and the second individual is present in the connection database. If so, a first individual's request to contact the second individual may be permitted. Otherwise, such request may be denied.

In another embodiment of the invention, a communication device is limited to facilitate communication (e.g., make phone call, receive phone call, send FaceTime request, receive FaceTime request, etc.) between a user of the communication device and only individuals listed in the contact list generated by automatic link generator (108 or 208), and perhaps one or more emergency contacts (e.g., police, hospital, etc.). Such communication device with a closed contact list is designed to protect children (and even seniors, or any other group of individuals) from contacting inappropriate and/or not previously authorized individuals.

In another embodiment of the invention, monitoring privileges are provided to certain members of a family (e.g., parents) or members of a group (e.g., network administrators). Monitoring privileges may be provided in numerous ways, such as allowing a parent to monitor all e-mail communication, wall postings, telephone calls, etc. of his/her child. Alternatively, all e-mails from a child may be automatically cc'ed to his/her parent. A child or other individual being monitored may be explicitly notified that his/her communication is being monitored by a parent or other individual. Upon a child or other individual being promoted, the degree of monitoring may be reduced and/or monitoring may be removed altogether.

In another embodiment of the invention, upon a child (or other individual) receiving increased privileges and/or autonomy over his/her social network account, the child's list of contacts may automatically populate a Gmail account or Facebook account.

In another embodiment of the invention, automatic links may be generated in response to other factors. For example, in response to an individual joining a company, the individual may be automatically linked to at least some individuals within the company via a social network (or more generally, a communication network). As another example, in response to a first company forming a relationship with a second company (e.g., a joint venture relationship, a subsidiary relationship, etc.), the accounts receivable personnel of the first company may be automatically linked to the accounts receivable personnel of the second company, the human resource personnel of the first company may be automatically linked to the human resource personnel of the second company, the accounting personnel of the first company may be automatically linked to the accounting personnel of the second company, etc. Automatically linking a first individual with a second individual may include populating a contact list of the first individual's email account, messaging account, or other account with the contact information of the second individual.

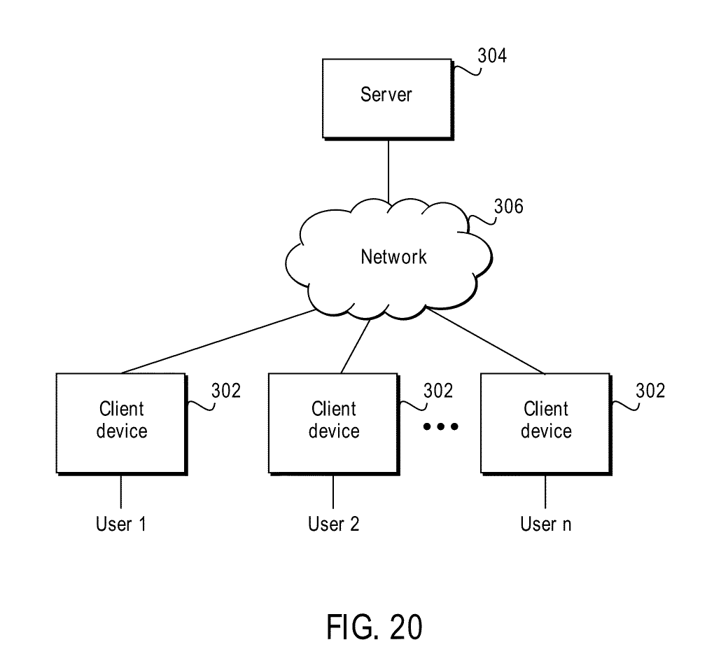

FIG. 20 depicts a typical connection between a plurality of client devices 302 and server 304 via network 306. It is understood that, in the discussion above, individuals (e.g., parents, children, teachers, students, etc.) interface with respective client devices 203 so as to communicate with one another over communication network 306 (e.g., social network). More specifically, individuals may interface with an application at least partially resident on one or more of the aforementioned client devices 302. Client devices 302 may be mobile devices, such as smart phones, laptops, etc., or may be non-mobile devices, such as a desktop computer. Therefore, the application configured to connect individuals may be platform independent (i.e., may be independent of the underlying hardware, operating system, particular social network, etc.) Client devices 302 are each communicatively coupled (e.g., wirelessly, electrically or optically connected) to network 306. Network 306 may be an Internet, connecting one network to another, a local area network (LAN), wide area network (WAN), metropolitan area network (MAN), etc. Also connected to network 306 are one or more servers 304 (although only one is depicted). Server 304 may control the communication between the aforementioned client devices 302, and/or may provide content to the aforementioned client devices 302. Server 304 may be one or more servers, any or some of which may be a mail server, news server, web server, server hosting a social network, etc.

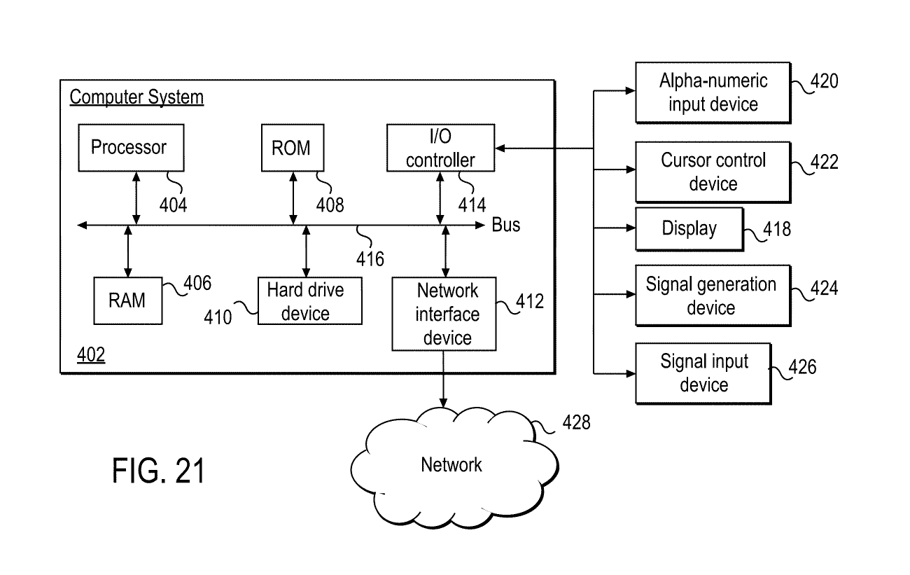

FIG. 21 of the accompanying drawings illustrates computer system 402, also known as a data processing system. The operations, processes, modules, methods, and systems described and shown in the accompanying figures of this disclosure are intended to operate on one or more computer systems as sets of instructions (e.g., software), also known as computer-implemented methods. Computer system 402 depicted in FIG. 21 is generally representative of any client device, server and/or mobile device (e.g., a mobile cellular device, Personal Digital Assistant (PDA), satellite phone, mobile Voice over Internet Protocol (VoIP) device, iPhone®, iPad®). Computer system 402 includes at least one processor 404 (e.g., a Central Processing Unit (CPU), a Graphics Processing Unit (GPU) or both), Random Access Memory (RAM) 406 (e.g., flash memory, Dynamic Random Access Memory (DRAM), Static Random Access Memory (SRAM), Synchronous DRAM (SDRAM), etc.), Read Only Memory (ROM) 408 (e.g., Erasable Programmable Read Only Memory (EPROM), Electrically Erasable Programmable Read Only Memory (EEPROM)), hard drive device 410 whether built-in, internal, external and/or removable (e.g., USB device, magnetic storage device, optical storage device, compact disk (CD) read/write device, digital video disk (DVD) read/write device, floppy disk read/write device, etc.), network interface device 412, and input/output (I/O) controller 414, which are communicatively coupled with one another other via one or more busses 416.

I/O controller 414 may interface computer system 402 with display 418 (e.g., Liquid Crystal Display (LCD), a Cathode Ray Tube (CRT) or a touch screen), alpha-numeric input device 420 (e.g., a keyboard, phone pad, touch screen), cursor control device 422 (e.g., a mouse, joy-stick, touch-pad), signal generation device 424 (e.g., a speaker), and signal input device 426 (e.g., a microphone, camera, fingerprint scanner, web-cam).

Network interface device 412 may include, for example, a network interface card (NIC), Ethernet card and/or dial-up modem, and may be communicatively coupled to network 428. In addition, network interface device 412 may be a wireless network interface device in the case of a mobile device communicatively coupled to network 428 (e.g., a cellular, VoIP and/or WiFi network). If the computer system is a server, alphanumeric input device 420, cursor control device 422, display 418, signal generation device 424 and/or signal input device 426 may be omitted.

One or more of ROM 408, RAM 406, and hard drive device 410 includes a computer-readable storage medium on which is stored one or more sets of computer-readable instructions (e.g., software) embodying one or more of the operations described herein. The computer-readable storage medium may include a single medium or multiple media (e.g., a centralized or distributed database, and/or associated caches and servers) that store the one or more sets of computer-readable instructions. The term “computer-readable storage medium” shall also be taken to include any physical/tangible medium that is capable of storing or encoding a set of instructions for execution by processor 404.

While numerous embodiments of the present invention have been described herein, it is not intended that such description limit the scope and/or broader spirit of the present invention. Rather, the scope of the present invention is defined only by the claims which follow.

What is claimed is:

1. A method, comprising:
receiving data identifying a first individual as a parent of a second individual, a third individual as a parent of a fourth individual, and a fifth individual as a parent of a sixth individual;
in response to data authorizing communication between the first and third individuals, permitting communication between the second and fourth individuals; and
in response to an absence of data authorizing communication between the first and fifth individuals, not permitting communication between the second and sixth individuals.

2. The method of claim 1, further comprising receiving data authorizing communication between the first and third individuals from the first individual.

3. The method of claim 1, further comprising, in response to data authorizing communication between children and acquaintances of parents, permitting communication between the second and third individuals.

4. The method of claim 1, further comprising, in response to data not authorizing communication between children and acquaintances of parents, not permitting communication between the second and third individuals.

5. A method, comprising:
receiving data identifying a first individual as a child in a first family, a second individual as a child in a second family, and a third individual as a child in a third family;
in response to data authorizing communication between the first and second families, permitting communication between the first and second individuals; and
in response to an absence of data authorizing communication between the first and third families, not permitting communication between the first and third individuals.

6. The method of claim 5, wherein the data identifying the first individual as a child in the first family and the data authorizing communication between the first and second families are received from a parent of the first individual.

7. A method, comprising:
receiving data identifying a first individual as a child in a first family and a second individual as a child in a second family; and
receiving data promoting the first individual from a child into an adult.

8. The method of claim 7, wherein upon the first individual being promoted from a child into an adult, permitting the first individual to communicate with adults from the second family.

9. The method of claim 7, wherein upon the first individual being promoted from a child into an adult, associating the first individual with a third family instead of the first family.

10. The method of claim 7, wherein upon the first individual being promoted from a child into an adult, permitting the first individual to authorize communication between the first and second families.
